(19) United States
(12) Patent Application Publication
(10) Pub. No.: US 2026/0178230 A1
(43) Pub. Date: Jun. 25, 2026

(54) TECHNIQUES FOR A SEQUENTIAL WRITE PROTECTION MODE IN A MEMORY SYSTEM

(71) Applicant: Micron Technology, Inc., Boise, ID (US)

(72) Inventors: Wenjun Wu, Shanghai (CN); Luca Porzio, Casalnuovo (NA) (IT); Fangfang Gao, Shanghai (CN); Zhou Zhou, Shanghai (CN); Pei Pei Jiang, Shanghai (CN); Xiao Wang, Shanghai (CN); Cun Chen, Shanghai (CN); Fei Chen, Shanghai (CN)

(21) Appl. No.: 19/391,773

(22) Filed: Nov. 17, 2025

Related U.S. Application Data
(60) Provisional application No. 63/738,430, filed on Dec. 23, 2024.

(51) Int. Cl. G06F 3/06

(52) U.S. Cl. CPC G06F 3/0659; G06F 3/0622; G06F 3/0679

(57) ABSTRACT

Methods, systems, and devices for techniques for a sequential write protection mode in a memory system are described. A memory system may receive one or more commands to write data to associated sequential memory addresses using a write automation block (WAB) while monitoring the addresses of the data. In the case that a write command may be associated with a non-sequential memory address, the memory system may store an associated pointer to a cache. The memory system may continue to write data indicated via incoming commands using the WAB until the memory system detects and writes the sequential command or a threshold quantity of commands have been received. If the threshold is reached prior to receiving the missing command, the memory system may disable the WAB and transmit an error message. The memory system may block and return error messages to any subsequent commands until the missing command is received.

### CROSS REFERENCE

The present Application for Patent claims priority to U.S. Provisional Patent Application No. 63/738,430 by Wu et al., entitled “TECHNIQUES FOR A SEQUENTIAL WRITE PROTECTION MODE IN A MEMORY SYSTEM,” filed Dec. 23, 2024, which is assigned to the assignee hereof, and which is expressly incorporated by reference in its entirety herein.

### TECHNICAL FIELD

The following relates to one or more systems for memory, including techniques for a sequential write protection mode in a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports techniques for a sequential write protection mode in a memory system in accordance with examples as disclosed herein.

FIG. 2 shows an example of a system that supports techniques for a sequential write protection mode in a memory system in accordance with examples as disclosed herein.

FIG. 3 shows an example of a process flow that supports techniques for a sequential write protection mode in a memory system in accordance with examples as disclosed herein.

FIG. 4 shows a block diagram of a memory system that supports techniques for a sequential write protection mode in a memory system in accordance with examples as disclosed herein.

FIG. 5 shows a flowchart illustrating a method or methods that support techniques for a sequential write protection mode in a memory system in accordance with examples as disclosed herein.

### DETAILED DESCRIPTION

Some memory systems may include a quantity of zones (e.g., cursors). To program the zones, the memory system may sequentially write to addresses of the zones using a sequential write restrict mode, a sequential write preferred mode, or other techniques. The sequential write restrict mode may include the memory system writing, using a write automation block (WAB), all data received from the host system to memory of the memory system automatically (e.g., without verifying whether the data is sequential). That is, the memory system may assume that the host is writing data sequentially. However, the host system may, in some examples, experience transient chaos, which may cause non-sequential write commands to be sent and written to the memory system in the sequential write restrict mode, which may thus reduce reliability of write operations. The sequential write preferred mode may include the memory system tracking each logical block address (LBA) that is written by the host system using a write pointer, or other metadata at the memory system. The memory system may use the metadata to ensure that the data is written sequentially. However, the tracking of each LBA may increase memory system overhead or otherwise may exceed an available memory capacity of the memory system, which may reduce reliability, reduce storage capacity, and increase latency of the memory system.

To reduce latency and overhead while supporting sequential writes to a zoned memory system, techniques for a write protection mode associated with both automated write operations as well as intermittent checks for sequential data may be implemented at the memory system. For example, a memory system may receive one or more commands to write data to zoned memory of the memory system. The memory system may operate in an automatic write mode for a first time period, such that the memory system may write the data to the associated memory addresses in accordance with the automatic write mode of the memory system (e.g., using the WAB or other automatic write logic circuitry without order checking prior to writing the data). The WAB may write the data to a cache automatically before the data is transferred from the cache to an intended zone within a memory device. The memory system (e.g., or a controller thereof) may monitor the addresses of the data in parallel with the automatic writing of the data. For example, the memory system controller may monitor the addresses written to the cache. If a write command is associated with a non-sequential memory address, the memory system controller may store a pointer to the non-sequential address in a cache of the memory system (e.g., using a metadata table, for example). For example, if three consecutive write commands are received and address LBAs one, two, and four, but not LBA three, the memory system controller may detect the skipped (e.g., non-sequential) LBA three and store a pointer to the LBA three. The data associated with the other LBAs may be written to the cache according to the automatic write mode and subsequently transferred to memory accordingly.

The memory system may continue to write data indicated via incoming commands according to the automatic write mode until the memory system controller detects a threshold quantity of commands have been received. The threshold quantity of commands may be a threshold quantity of commands received after the non-sequential command and before the missing LBA is received. Additionally, or alternatively, even if the received commands are each sequential, the memory system controller may detect that a threshold quantity of commands have been received within a given time period, where the threshold quantity may be associated with a capacity of the cache. In response to the threshold quantity of commands being reached, the memory system may disable the automatic write mode and transmit an error message in response to any further received write commands. The memory system may block and return error messages to any subsequent commands until the missing command that indicates data for the skipped LBA is received, or until the cache capacity is increased (e.g., the data is transferred to memory), or both. Once the missing command is received, the memory system may write the associated data and the cached data to the memory addresses according to the sequence. Use of a write protection mode may allow the memory system to receive a relatively large quantity of write commands automatically (e.g., regardless of the order) while still reducing errors associated with non-sequential writes, which may increase efficiency of zoned-memory write operations at the memory system.

In addition to applicability in memory systems as described herein, techniques for a sequential write protection mode may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease processing or latency times, improve response times, or otherwise improve user experience, among other benefits.

In addition to applicability in memory systems described herein, techniques for a sequential write protection mode may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by monitoring each incoming write command and performing intermittent checks for sequential data, and may prevent or mitigate unauthorized access to data or other information, incur lower latency costs, use less power relative to other solutions, among other benefits.

In addition to applicability in memory systems as described herein, techniques for a sequential write protection mode may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by reducing a quantity of write operations, which may extend the life of electronic devices and thereby reduce electronic waste, among other benefits.

Features of the disclosure are illustrated and described in the context of systems, devices, and circuits. Features of the disclosure are further illustrated and described in the context of process flows and flowcharts.

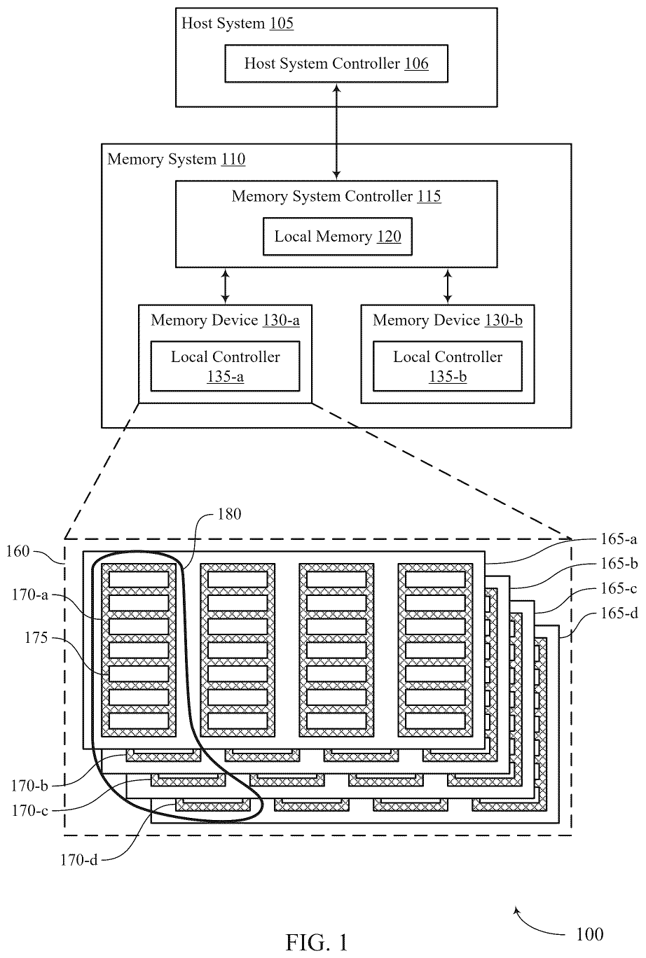

FIG. 1 shows an example of a system 100 that supports techniques for a sequential write protection mode in a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block 1 within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The memory system 110 may include a quantity of zones (e.g., cursors). To program the zones, the memory system 110 may sequentially write to addresses of the zones using a sequential write restrict mode, a sequential write preferred mode, or other techniques. The sequential write restrict mode may include the memory system 110 writing, according to an automatic write mode, data received from the host system to addresses of the memory system 110 automatically (e.g., without verifying if the data is sequential). However, if the host system 105 experiences transient chaos, the host system 105 may write one or more non-sequential write commands, which may be automatically written to the memory system 110, thus reducing reliability of write operations. The sequential write preferred mode may include the memory system 110 tracking each LBA that is written to using a write pointer, or other metadata. However, the tracking of each LBA may increase memory system 110 overhead or otherwise may exceed an available memory capacity of the memory system 110, which may reduce reliability, reduce storage capacity, and increase latency of the memory system 110.

To reduce latency and overhead while supporting sequential writes to the memory system 110, techniques for a write protection mode associated with both automated write operations as well as intermittent checks for sequential data may be implemented at the memory system 110. For example, the memory system 110 may receive one or more commands to write data to zoned memory of the memory system 110. The memory system 110 may operate in an automatic write mode for a first time period, such that the memory system 110 may write the data to the associated LBAs in accordance with the automatic write mode of the memory system (e.g., using the WAB or other automatic write logic circuitry without order checking prior to writing the data). The WAB may write the data to a cache automatically before the data is transferred from the cache to an intended zone within a memory device 130. The memory system 110 (e.g., or the memory system controller 115) may monitor the LBA of the data in parallel with the automatic writing of the data. For example, the memory system controller may monitor the addresses written to the cache. If a write command is associated with a non-sequential LBA, the memory system 110 controller may store a pointer to the non-sequential address in a cache of the memory system (e.g., using a metadata table, for example). For example, if three consecutive write commands are received and address LBAs one, two, and four, but not LBA three, the memory system controller 115 may detect the skipped (e.g., non-sequential) LBA three and store a pointer to the LBA three. The data associated with the other LBAs may be written to the cache according to the automatic write mode and subsequently transferred to memory accordingly.

The memory system 110 may continue to write data indicated via incoming commands according to the automatic write mode until the memory system controller 115 detects a threshold quantity of commands have been received. The threshold quantity of commands may be a threshold quantity of commands received after the non-sequential command and before the missing LBA is received. Additionally, or alternatively, even if the received commands are each sequential, the memory system controller may detect that a threshold quantity of commands have been received within a given time period, where the threshold quantity may be associated with a capacity of the cache. In response to the threshold quantity of commands being reached, the memory system 110 may disable the automatic write mode and transmit an error message in response to any further received write commands. The memory system 110 may block and return error messages to any subsequent commands until the missing command that indicates data for the skipped LBA is received, or until the cache capacity is increased (e.g., the data is transferred to memory), or both. Once the missing command is received, the memory system 110 may write the associated data and the cached data to the LBAs according to the sequence. Use of a write protection mode may allow the memory system 110 to receive a relatively large quantity of write commands automatically (e.g., regardless of the order) while still reducing errors associated with non-sequential writes, which may increase efficiency of zoned-memory write operations at the memory system 110.

The system 100 may include any quantity of non-transitory computer readable media that support techniques for a sequential write protection mode in memory systems. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

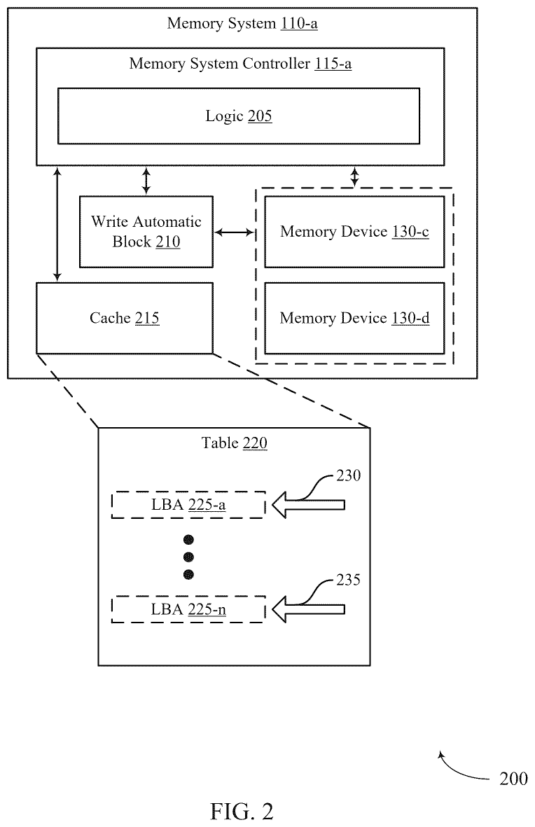

FIG. 2 shows an example of a system 200 that supports techniques for a sequential write protection mode in memory systems in accordance with examples as disclosed herein. The system 200 may be an example of a system 100 as described with reference to FIG. 1, or aspects thereof. The system 200 may include a memory system 110-a configured to store data received from a host system (e.g., a host system 105, as described with reference to FIG. 1) and to send data to the host system, if requested by the host system using access commands (e.g., read commands or write commands). The system 200 may implement aspects of the system 100 as described with reference to FIG. 1. For example, the memory system 110-a, the memory system controller 115-a, and the memory devices 130 may be examples of the memory system 110, the memory system controller 115, and the memory devices 130 as described with reference to FIG. 1, respectively. The memory system 110-a may include a cache 215 for temporarily storing data to be written to the memory devices 130, as well as other temporary data or metadata, such as the table 220.

The memory system 110-a may include one or more memory devices 130, such as the memory device 130-c and the memory device 130-d. In some examples, the memory device 130-c and the memory device 130-d may include zoned memory (e.g., may be examples of zUFS memory devices). For example, the memory devices 130-c and 130-d may be associated with a zoned namespace configuration that may divide non-volatile memory of the memory devices 130-c and 130-d (e.g., NAND memory) into one or more independent zones that may support specific data or operations. A zone may include one or more physical memory blocks associated with physical addresses that may be mapped to respective LBAs 225, as described in further detail elsewhere herein, including with reference to FIG. 1. In some zoned namespace configurations, blocks in a zone may be written to sequentially (e.g., in sequential LBA order). The use of these zones may enable multiple components or systems to share the non-volatile memory of the memory devices 130, which may lead to decreased costs and higher performance.

The memory system 110-a may perform various operations on the components of the memory system 110-a using various techniques. For example, the memory system controller 115-a may receive a command from an associated host system (e.g., via the memory system 110-a) and may perform one or more operations on the memory devices 130 or a cache 215 of the memory system 110-a. In some examples, the memory system 110-a may perform one or more operations using a WAB 210 or the memory system controller 115-a (e.g., via logic 205). For example, the memory system controller 115-a may use the logic 205 to access (e.g., read from, write to) the memory devices 130 and perform other operations at other components of the memory system 110-a (e.g., such as the cache 215).

The memory system 110-a may use the WAB 210, which may be an example of circuitry or other logic within the memory system 110-a, to write data to the memory devices 130 in accordance with an automatic write mode, which may be referred to as a sequential write restrict (SWR) mode herein. For example, when enabled by the memory system 110-a, the WAB 210 may receive commands from an associated host system and automatically write data associated with the commands to the cache 215 for subsequent transfer to the memory devices 130. When operating according to the SWR mode, the WAB 210 may not verify if an LBA 225 associated with each received write command is sequential to an LBA of a previously received write command, but may instead assume that the LBAs are sequential and write the data accordingly. Without checking for sequence in received commands, the memory system 110-a may be negatively impacted in the case that a write command associated with a non-sequential LBA 225 is received. For example, if the memory system 110-a receives a write command associated with a non-sequential LBA 225 of the memory devices 130 (e.g., due to a sequence-checker of the host system failing) while operating according to the SWR mode, the WAB 210 may not be enabled to reject the write command and may write the data without verifying that the write command is associated with a sequential LBA 225. In some cases, an auto-response feature may be enabled, and the memory system 110-a may write invalid or wrong data before performing a verification operation. The mismanagement of sequential data that may result from use of the SWR mode may result in increased operation times and relatively low reliability at the memory system 110-a.

The memory system 110-a may also be configured to operate in an SWP mode. For example, when operating in the SWP mode, the WAB 210 may be disabled. The memory system controller 115-a may be configured to track the LBA 225 associated with each incoming write command received from the host system using a write pointer or other metadata. Tracking the LBA 225 associated with each received write command may enable the memory system 110-a to verify the sequence associated with the LBAs 225. However, the memory system controller 115-a may not be able to track every single LBA 225 received from the host system due to storage and operating system constraints. In the case that a host system may transmit a write command associated with a non-sequential LBA 225, the WAB 210 may be unable to verify the associated sequence, or the tracking of which may increase overhead of the memory system 110-a or otherwise exceed an available memory capacity of the memory system 110-a, which may reduce reliability, storage capacity, and increase latency of the memory system 110-a.

To reduce latency and overhead while supporting sequential writes to the memory devices 130, the memory system 110-a described herein may operate according to a write protection mode associated with automated write operations while performing intermittent checks for sequential data. For example, the memory system 110-a may receive one or more commands to write data to zones of the memory devices 130 (e.g., associated with LBAs 225). When operating according to the write protection mode, the memory system 110-a may write the data to the zoned memory associated with the LBAs 225 without order checking using the WAB 210. That is, the WAB 210 may default to being enabled for automatic writes initially. The memory system 110-a (e.g., or the memory system controller 115-a) may monitor the LBAs 225 associated with the incoming write commands in parallel with the WAB 210 writing the data to the physical memory blocks. In some examples, the WAB 210 may write the data to the cache for some time before the data is transferred to the memory devices 130.

The memory system controller 115-a may monitor the cache 215 and track LBAs 225 accordingly. If a received write command is associated with a non-sequential LBA 225 (e.g., an LBA 225 that is not sequential with an LBA 225 received via a previously received write command), the memory system controller 115-a may generate the table 220 at the cache 215, and may store a skipped address pointer 230 (e.g., an internal pointer) that points to the non-sequential LBA 225 (e.g., LBA 225-a, for example) to the table 220. For example, after receiving a write command associated with a first LBA 225, the memory system controller 115-a may determine that an incoming write command is associated with a third LBA 225, which indicates that the host system failed to send a write command associated with a second LBA 225 (e.g., the LBA 225-a) that is sequential to the first LBA 225. The memory system 110-a may continue to receive incoming write commands that are not associated with the skipped LBA 225-a and write the corresponding data to the cache 215 according to the automatic write mode, and may set the skipped address pointer 230 to the LBA 225-a. The memory system controller 115-a may leave the skipped address pointer 230 pointing to the LBA 225-a until a write command associated with the LBA 225-a is received. It is to be understood that the table 220 may store one or more pointers that point to LBAs 225 of the memory devices, but may not directly store LBAs 225-a through 225-n.

In some examples, after setting the skipped address pointer 230 to the LBA 225-a and while continuing to receive incoming write commands, the memory system controller 115-a may determine that the host system failed to send another write command associated with an LBA 225 (e.g., prior to the host system transmitting the missing command and prior to a threshold associated with the cache being satisfied). In the case that the memory system 110-a may receive the missing write command associated with the LBA 225-a, the memory system controller 115-a may move the skipped address pointer 230 to the second skipped LBA 225 associated with the second missing write command, or the memory system controller 115-a may store two or more pointers that point to each missing LBA 225.

For each write operation performed, the memory system controller 115-a may move a write pointer 235 of the table 220 to point to a latest LBA 225 in the sequence of LBAs 225. For example, after receiving the write command associated with the third LBA 225 and setting the skipped address pointer 230 to LBA 225-a (e.g., the second LBA), the memory system controller 115-a may write data to the third LBA 225 and may set the write pointer 235 to the third LBA 225 while keeping the skipped address pointer 230 pointing to the LBA 225-a (e.g., the second LBA). The memory system controller 115-a may continue to move the write pointer 235 after each write operation performed at the LBAs 225, such that a latest LBA 225 in the sequence may be indicated.

The memory system 110-a may continue to write data indicated via incoming write commands using the WAB 210 and in accordance with the automatic write mode until the memory system controller 115-a receives the missing write command, until another trigger for disabling the WAB 210 is identified, or until a threshold quantity of write commands have been received and associated data is stored to the cache 215. In some examples, the threshold quantity of write commands may be associated with a size (e.g., capacity) of the cache 215. In other examples, the threshold quantity of write commands may be associated with a quantity (e.g., count) of write commands received after the host system failed to transmit the write command associated with the skipped LBA 225-a and before the skipped LBA 225-a is received successfully. In some examples, the memory system 110-a (e.g., the memory system controller 115-a) may include a counter, and may increment the counter for every received write command associated with a non-sequential LBA 225 (e.g., associated with each LBA 225 that is not the skipped LBA-a). For example, after failing to receive the write command associated with the LBA 225-a, the memory system controller 115-a may increment the counter for each write command received instead of the write command associated with the skipped LBA 225-a.

If a quantity of incoming write commands satisfies the threshold quantity of write commands prior to receipt of the missing write command (e.g., the command associated with the LBA 225-a), the memory system 110-a may disable the WAB 210 and transmit an error message to the host system. For example, after receiving each write command, the memory system controller 115-a may compare the count of the counter to the threshold quantity of write commands. In the case that the count does not satisfy the threshold, the memory system 110-a may continue to receive and cache write commands according to the automatic write mode and using the WAB 210. If the count satisfies the threshold, the memory system 110-a may disable the WAB 210 and transmit the error message in response to the current write command. The error message may indicate to the host system that the write command associated with the non-sequential LBA 225 is an illegal request, that the associated LBA 225 is out of range, or is non-sequential (e.g., unaligned). In some examples, the host system may transmit other write commands in response to receiving the error message. The memory system controller 115-a may continue to determine whether each incoming write command may be associated with the skipped LBA 225-a, and may block write commands and return error messages in response to the write commands not being associated with the skipped LBA 225-a. In the case that the host system may transmit multiple write commands that are not associated with the skipped LBA 225-a after receiving the error message, the memory system controller 115-a may continue to block the write commands until the missing command is received.

The memory system 110-a may receive a write command associated with the skipped LBA 225-a and may write the data to the LBA 225-a according to a manual write mode. For example, after disabling the WAB 210, the memory system 110-a may receive the missing write command from the host system. The memory system controller 115-a may verify the LBA 225-a is correct using the skipped address pointer 230 and may manually write the data associated with the missing write command (e.g., using the logic 205) to the LBA 225-a. The memory system controller 115-a may transmit a success message to the host system. After writing data to the skipped LBA 225-a, the memory system controller 115-a may delete (e.g., remove) the skipped address pointer 230, may disable the sequential write protection mode, and may reenable the automatic write mode and the WAB 210. The host system may resume sending write commands, and the WAB 210 may resume writing associated data to the LBAs 225 using the write pointer 235. Once the previously-skipped LBA 225-a has been written to and the WAB 210 has resumed writing to the sequence of LBAs 225, the memory system controller 115-a may delete the table 220, in some examples.

Enabling a sequential write protection mode at the system 200 may allow the memory system 110-a to receive all write commands regardless of whether the write commands are in sequential order or not, while still writing according to the sequence. Enabling the memory system 110-a to receive all write commands, may increase the efficiency of zoned memory operations at the memory system 110-a and improve reliability of the system 200.

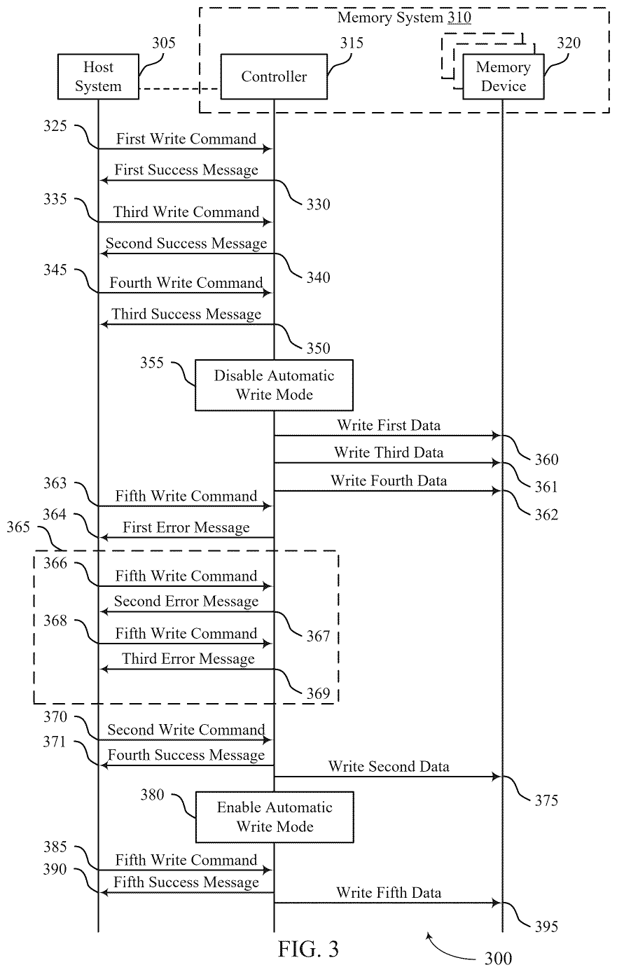

FIG. 3 shows an example of a process flow 300 that supports techniques for a sequential write protection mode in a memory system in accordance with examples as disclosed herein. The operations of process flow 300 may be performed by a memory system or one or more controllers associated with a memory system as described herein. For example, the process flow 300 may illustrate exchanges of data and metadata between one or more memory devices 320 and a controller 315 within a memory system 310, and between the memory system 310 and a host system 305, which may represent examples of corresponding systems and dies as described with reference to FIGS. 1 and 2. The memory devices 320 may include one or more LBAs, which may be examples of LBAs as described with reference to FIGS. 1 and 2. The memory system 310 may include a cache (e.g., not illustrated), which may be an example of a cache 215 as described with reference to FIG. 2.

One or more write commands indicating data to be written to one or more LBAs of the memory system 310 may be communicated. In some examples, the LBAs may be sequential LBAs associated with a zone of the zoned memory of the memory devices 320. At 325, a first write command may be communicated. For example, the host system 305 may transmit, and the controller 315 may receive, a first write command indicating first data to be written to a first LBA of a memory device 320. At 330, a first success message may be communicated. For example, in response to receiving the first write command, the controller 315 may transmit a first success message to the host system 305 indicating that the memory system 310 successfully received the first write command. At 335, a third write command may be communicated. For example, the host system 305 may transmit, and the controller 315 may receive, a third write command indicating third data to be written to a third LBA of the memory device 320. At 340, a second success message may be communicated. For example, in response to receiving the third write command, the controller 315 may transmit a second success message to the host system 305 indicating that the memory system 310 successfully received the third write command. The memory system 310 may perform the one or more write commands according to an automatic write mode. For example, a WAB of the memory system 310 may temporarily write the data associated with the one or more write commands to a cache of the memory system 310 without verifying the order of the one or more write commands relative to a sequence.

As described herein, to improve reliability of the automatic writes, the controller 315 may monitor the data written to the cache during the automatic write mode. In this example, the controller 315 may determine that the third LBA associated with the third write command may not be sequential to the first LBA associated with the previously received first write command (e.g., via a write pointer, as described herein), and may generate a table within a cache of the memory system 310. As further described herein with reference to FIG. 2, the controller 315 may generate a skipped address pointer to point to the LBA associated with the missing sequential write command (e.g., a second LBA, the skipped LBA, a target LBA) and may store the skipped address pointer to the table until the missing write command is received. The controller 315 may also increment a value of a counter for each write command received after the third write command and instead of the missing write command (e.g., each write command that is not associated with the second LBA).

One or more other write commands associated with non-sequential LBAs may be received and cached until the missing write command is received. For example, at 345, a fourth write command may be communicated. For example, the host system 305 may transmit, and the controller 315 may receive, a fourth write command indicating fourth data to be written to a fourth LBA of the memory device 320. In some examples, although the fourth LBA may be sequential to the previously received third LBA, the fourth LBA may still be referred to as a non-sequential LBA since the second LBA has not yet been received and is still missing. At 350, a third success message may be communicated. For example, in response to receiving the fourth write command and determining that the cache is available to store another write command that is not the missing write command (e.g., determining that the value of the counter does not satisfy a threshold quantity of write commands), the WAB of the memory system 310 may cache the fourth write command and the controller 315 may transmit a third success message to the host system 305 indicating that the memory system 310 successfully received the fourth write command.

At 355, the automatic write mode may be disabled. In response to receiving and caching the fourth write command, the memory system 310 may determine that a quantity of commands stored to the cache satisfies a threshold quantity of commands (e.g., may determine the cache to be full). For example, the memory system 310 may monitor the cache, and may compare a quantity of stored write commands to a threshold quantity of write commands. In some examples, the threshold quantity may be associated with the size of the cache, a quantity of write commands received since the second write command was skipped, or both, as described further herein. In response to determining the threshold to be satisfied (e.g., prior to receiving the missing write command), the memory system 310 may disable the WAB (e.g., disable the automatic write mode).

Data associated with the one or more write commands may be written to the memory device 320. For example, in response to the WAB receiving and temporarily caching the one or more write commands and the controller 315 transmitting the first error message (e.g., at 360), the controller 315 may write data associated with the received write commands to the memory device 320. In response to receiving the first write command, the controller 315 may have generated a write pointer that points to the latest LBA written to by the controller 315.

At 360, first data may be written. For example, the controller 315 may write first data associated with the first write command from the cache to a physical address associated with the first LBA of the memory device 320, which may be the next available LBA after the LBA indicated by the write pointer. The controller 315 may move the write pointer to point to the first LBA in response to writing to the first LBA. Additionally, or alternatively, the controller 315 may move the write pointer as the data is written to the cache, and the transfer of data from the cache to the memory device 320 may be performed in the background independently from the pointer adjustments. At 361, third data may be written. For example, the controller 315 may write third data associated with the third write command from the cache to a physical address associated with the third LBA of the memory device 320. That is, the controller 315 may skip over the second LBA pointed to by the skipped address pointer (e.g., because data associated with the second LBA may not yet be written into the cache), and may write the third data to the next available LBA in the sequence after the LBA pointed to by the write pointer (e.g., the third LBA). After writing the third data to the third LBA, the controller 315 may move the write pointer to point to the third LBA. Additionally, or alternatively, the controller 315 may move the write pointer as the data is written to the cache, and the transfer of data from the cache to the memory device 320 may be performed in the background independently from the pointer adjustments. At 362, fourth data may be written. For example, the controller 315 may write fourth data associated with the fourth write command from the cache to the next available LBA in the sequence after the LBA pointed to by the write pointer, which may be a physical address associated with the fourth LBA of the memory device 320. The controller 315 may move the write pointer to point to the fourth LBA in response to writing the fourth data to the fourth LBA. Additionally, or alternatively, the controller 315 may move the write pointer as the data is written to the cache, and the transfer of data from the cache to the memory device 320 may be performed in the background independently from the pointer adjustments. In some examples, the WAB may automatically write the data to the cache, and to write the data to the memory device 320, the controller 315 may transfer the data from the cache to the memory device 320 during a background operation of the memory system 310. The controller 315 may transfer the data prior to disabling the automatic write mode (e.g., prior to 355), after disabling the automatic write mode, during other operations of the memory system 310, or any combination thereof.

At 363, a fifth write command may be communicated. For example, the host system 305 may transmit, and the controller 315 may receive, a fifth write command indicating fifth data to be written to a fifth LBA of the memory device 320. At 364, a first error message may be communicated. For example, in response to receiving the fifth write command and determining that the fifth write command is not associated with the skipped LBA, the controller 315 may transmit a first error message to the host system 305. Because the WAB is disabled, the WAB may not cache the fifth command. In some examples, the first error message may indicate that the fifth write command includes an illegal request, that the LBA associated with the fifth write command is out of range, that the fifth write command is associated with a non-sequential LBA, that the threshold has been satisfied, or a combination thereof.

At 365, one or more other write commands associated with non-sequential LBAs may be communicated. In some examples, after receiving the first error message at 364, the host system 305 may repeat transmission of the last-transmitted write command (e.g., the fifth write command). For example, at 366, the fifth write command may be re-transmitted. For example, the host system 305 may re-transmit the fifth write command to the memory system 310. In response to receiving the fifth write command, the controller 315 may determine the fifth write command to be associated with an LBA that is not the skipped LBA (e.g., may determine the fifth write to not be the missing write command), and may transmit a second error message to the host system 305 at 367. At 368, the fifth write command may be re-transmitted. For example, the host system 305 may again re-transmit the fifth write command to the memory system 310. In response to receiving the fifth write command, the controller 315 may determine the fifth write command to be associated with an LBA that is not the skipped LBA (e.g., may determine the fifth write to not be the missing write command), and may transmit a third error message to the host system 305 at 369. The second error message and the third error message may be a same or similar error message as the first error message. The controller 315 may continue to determine whether received write commands are associated with the target LBA, and may continue to transmit error messages in response to any received write command that may not be associated with the skipped LBA.

At 370, a second write command may be transmitted. For example, the host system 305 may transmit, and the controller 315 may receive, a second write command indicating second data to be written to the second LBA (e.g., the target LBA, the skipped LBA) of the memory device 320.

At 371, a fourth success message may be transmitted. For example, in response to receiving the second write command, the controller 315 may transmit a fourth success message to the host system 305 indicating that the memory system 310 successfully received the second write command.

At 375, second data may be written to the memory device 320. For example, in response to receiving the second write command and determining that the second write command is associated with the skipped LBA, the controller 315 may write the second data associated with the second write command to the skipped LBA (e.g., the second LBA) pointed to by the skipped address pointer. The controller 315 may write the second data to the second LBA according to a manual write mode of the memory system 310. After writing the second data to the skipped LBA, the controller 315 may delete (e.g., remove) the skipped address pointer. In the case that two LBAs may have been skipped, the controller 315 may not delete the skipped address pointer, but may move the skipped address pointer to the next skipped LBA.

At 380, the automatic write mode of the memory system 310 (e.g., the WAB) may be enabled. For example, in response to receiving the second write command associated with the skipped LBA (e.g., the target LBA) and writing the second data to the skipped LBA, the controller 315 may re-enable the automatic write mode of the memory system 310.

At 385, the fifth write command may be re-transmitted. For example, after transmitting the second write command associated with the skipped LBA (e.g., the target LBA), the host system 305 may re-transmit the fifth write command indicating fifth data to be written to the fifth LBA of the memory system 310. In response to re-enabling the automatic write mode of the memory system 310, the controller 315 may receive the fifth write command.

At 390, a fifth success message may be transmitted. For example, in response to receiving the fifth write command after writing the second data to the skipped LBA and re-enabling the automatic write mode, the controller 315 may transmit a fifth success message to the host system 305 indicating that the memory system 310 successfully received the fifth write command.

At 395, fifth data may be written to the memory device 320. For example, in response to receiving the fifth write command, the controller 315 may write the fifth data associated with the fifth write command to the fifth LBA pointed to by the write pointer. In some examples, the WAB may write the fifth data to the cache according to the automatic write mode of the memory system 310, and the controller 315 may move the fifth data from the cache to the memory device 320 at 395 during a background operation. After writing the fifth data to the fifth LBA, the controller 315 may move the write pointer to point to the fifth LBA.

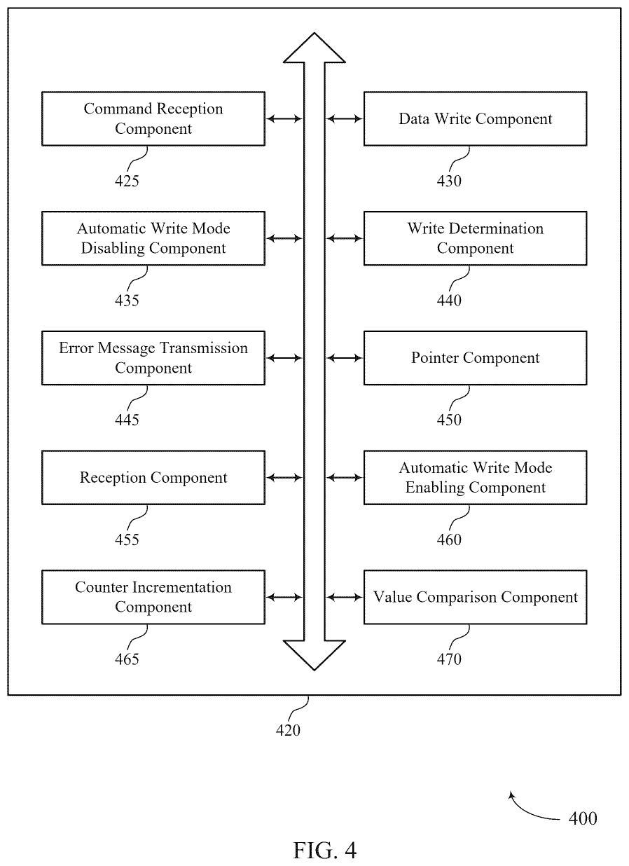

FIG. 4 shows a block diagram 400 of a memory system 420 that supports techniques for a sequential write protection mode in a memory system in accordance with examples as disclosed herein. The memory system 420 may be an example of aspects of a memory system as described with reference to FIGS. 1 through 3. The memory system 420, or various components thereof, may be an example of means for performing various aspects of techniques for a sequential write protection mode in a memory system as described herein. For example, the memory system 420 may include a command reception component 425, a data write component 430, an automatic write mode disabling component 435, a write determination component 440, an error message transmission component 445, a pointer component 450, a reception component 455, an automatic write mode enabling component 460, a counter incrementation component 465, a value comparison component 470, or any combination thereof. Each of these components, or components of subcomponents thereof (e.g., one or more processors, one or more memories), may communicate, directly or indirectly, with one another (e.g., via one or more buses).

The command reception component 425 may be configured as or otherwise support a means for receiving a plurality of first write commands that indicate first data to be written to a plurality of first logical block addresses within a memory system. The data write component 430 may be configured as or otherwise support a means for writing, in accordance with an automatic write mode of the memory system and the plurality of first logical block addresses, the first data to the memory system in response to the plurality of first write commands. The automatic write mode disabling component 435 may be configured as or otherwise support a means for disabling the automatic write mode of the memory system in accordance with a quantity of first write commands included in the plurality of first write commands satisfying a threshold. The write determination component 440 may be configured as or otherwise support a means for determining, in accordance with disabling the automatic write mode and a condition associated with a second write command that indicates a second logical block address, whether to write second data indicated via the second write command to the memory system.

In some examples, the error message transmission component 445 may be configured as or otherwise support a means for transmitting, in accordance with determining not to write the second data to the memory system, an error message that indicates the second write command is invalid.

In some examples, the reception component 455 may be configured as or otherwise support a means for receiving a retransmission of the second write command or a third write command in response to the error message.

In some examples, the error message transmission component 445 may be configured as or otherwise support a means for transmitting, in response to one or more third write commands, one or more error messages until a fourth write command that indicates a target logical block address is received, where the condition includes the target logical block address, and where determining not to write the second data to the memory system is in accordance with the second logical block address indicated via the second write command being different from the target logical block address.

In some examples, the command reception component 425 may be configured as or otherwise support a means for receiving the fourth write command that indicates the target logical block address. In some examples, the automatic write mode enabling component 460 may be configured as or otherwise support a means for re-enabling the automatic write mode of the memory system in response to the fourth write command that indicates the target logical block address. In some examples, the command reception component 425 may be configured as or otherwise support a means for receiving, after re-enabling the automatic write mode, a retransmission of the second write command. In some examples, the data write component 430 may be configured as or otherwise support a means for writing, in accordance with the automatic write mode, the second data to the memory system in response to the retransmission of the second write command.

In some examples, the data write component 430 may be configured as or otherwise support a means for writing, in accordance with determining to write the second data to the memory system and in accordance with a manual write mode of the memory system, the second data indicated via the second write command to the memory system.

In some examples, the automatic write mode enabling component 460 may be configured as or otherwise support a means for re-enabling the automatic write mode of the memory system in accordance with the second logical block address including a target logical block address, where determining to write the second data to the memory system is in accordance with the second logical block address including the target logical block address.

In some examples, the threshold includes a threshold quantity of commands associated with a size of a cache of the memory system; and the condition for determining whether to write the second data to the memory system includes an amount of available memory within the cache.

In some examples, the plurality of first logical block addresses are included in a set of sequential logical block addresses associated with a zone of memory within the memory system; at least one first write command of the plurality of first write commands skips a sequential logical block address of the set of sequential logical block addresses; and the threshold includes a threshold quantity of commands including the at least one first write command and one or more other first write commands received after the at least one first write command and before a target write command including the skipped sequential logical block address.

In some examples, the counter incrementation component 465 may be configured as or otherwise support a means for incrementing a value of a counter in response to receipt of each of the at least one first write command and the one or more other first write commands. In some examples, the value comparison component 470 may be configured as or otherwise support a means for comparing the value of the counter to the threshold, where the automatic write mode of the memory system is disabled in response to the value of the counter satisfying the threshold.

In some examples, the pointer component 450 may be configured as or otherwise support a means for generating, in response to receipt of the at least one first write command, a skipped address pointer that points to the skipped sequential logical block address.

In some examples, the command reception component 425 may be configured as or otherwise support a means for receiving a third write command that indicates third data to be written to the skipped sequential logical block address. In some examples, the data write component 430 may be configured as or otherwise support a means for writing the third data to the memory system in accordance with the third write command. In some examples, the pointer component 450 may be configured as or otherwise support a means for deleting the skipped address pointer in response to writing the third data to the memory system.

In some examples, the pointer component 450 may be configured as or otherwise support a means for generating, in response to a first write command of the plurality of first write commands, a write pointer to a third logical block address of the plurality of first logical block addresses that is indicated via the first write command. In some examples, the pointer component 450 may be configured as or otherwise support a means for updating, in response to receipt of each first write command of the plurality of first write commands, the write pointer to point to a respective first logical block address of the plurality of first logical block addresses indicated via a most recently received first write command.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

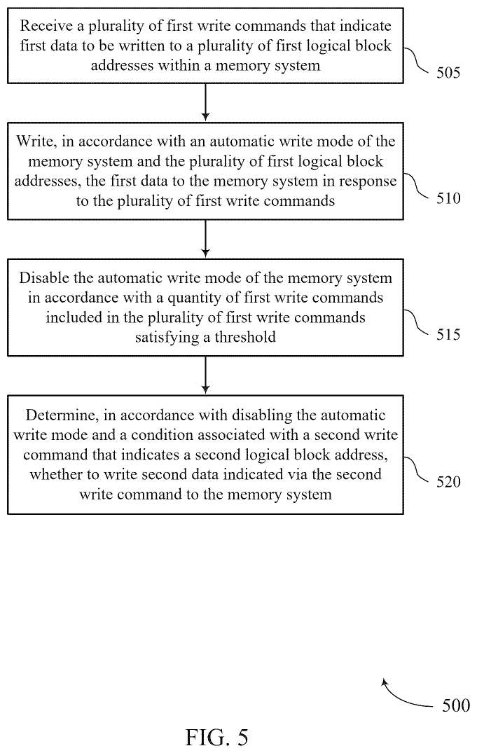

FIG. 5 shows a flowchart illustrating a method 500 that supports techniques for a sequential write protection mode in a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving a plurality of first write commands that indicate first data to be written to a plurality of first logical block addresses within a memory system. In some examples, aspects of the operations of 505 may be performed by a command reception component 425 as described with reference to FIG. 4.

At 510, the method may include writing, in accordance with an automatic write mode of the memory system and the plurality of first logical block addresses, the first data to the memory system in response to the plurality of first write commands. In some examples, aspects of the operations of 510 may be performed by a data write component 430 as described with reference to FIG. 4.

At 515, the method may include disabling the automatic write mode of the memory system in accordance with a quantity of first write commands included in the plurality of first write commands satisfying a threshold. In some examples, aspects of the operations of 515 may be performed by an automatic write mode disabling component 435 as described with reference to FIG. 4.

At 520, the method may include determining, in accordance with disabling the automatic write mode and a condition associated with a second write command that indicates a second logical block address, whether to write second data indicated via the second write command to the memory system. In some examples, aspects of the operations of 520 may be performed by a write determination component 440 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a plurality of first write commands that indicate first data to be written to a plurality of first logical block addresses within a memory system; writing, in accordance with an automatic write mode of the memory system and the plurality of first logical block addresses, the first data to the memory system in response to the plurality of first write commands; disabling the automatic write mode of the memory system in accordance with a quantity of first write commands included in the plurality of first write commands satisfying a threshold; and determining, in accordance with disabling the automatic write mode and a condition associated with a second write command that indicates a second logical block address, whether to write second data indicated via the second write command to the memory system.

Aspect 2: The method, apparatus, or non-transitory computer-readable medium of aspect 1, further including operations, features, circuitry, logic, means, or instructions, or any combination thereof for transmitting, in accordance with determining not to write the second data to the memory system, an error message that indicates the second write command is invalid.

Aspect 3: The method, apparatus, or non-transitory computer-readable medium of aspect 2, further including operations, features, circuitry, logic, means, or instructions, or any combination thereof for receiving a retransmission of the second write command or a third write command in response to the error message.

Aspect 4: The method, apparatus, or non-transitory computer-readable medium of any of aspects 2 through 3, further including operations, features, circuitry, logic, means, or instructions, or any combination thereof for transmitting, in response to one or more third write commands, one or more error messages until a fourth write command that indicates a target logical block address is received, where the condition includes the target logical block address, and where determining not to write the second data to the memory system is in accordance with the second logical block address indicated via the second write command being different from the target logical block address.

Aspect 5: The method, apparatus, or non-transitory computer-readable medium of aspect 4, further including operations, features, circuitry, logic, means, or instructions, or any combination thereof for receiving the fourth write command that indicates the target logical block address; re-enabling the automatic write mode of the memory system in response to the fourth write command that indicates the target logical block address; receiving, after re-enabling the automatic write mode, a retransmission of the second write command; and writing, in accordance with the automatic write mode, the second data to the memory system in response to the retransmission of the second write command.

Aspect 6: The method, apparatus, or non-transitory computer-readable medium of any of aspects 1 through 5, further including operations, features, circuitry, logic, means, or instructions, or any combination thereof for writing, in accordance with determining to write the second data to the memory system and in accordance with a manual write mode of the memory system, the second data indicated via the second write command to the memory system.

Aspect 7: The method, apparatus, or non-transitory computer-readable medium of aspect 6, further including operations, features, circuitry, logic, means, or instructions, or any combination thereof for re-enabling the automatic write mode of the memory system in accordance with the second logical block address including a target logical block address, where determining to write the second data to the memory system is in accordance with the second logical block address including the target logical block address.

Aspect 8: The method, apparatus, or non-transitory computer-readable medium of any of aspects 1 through 7, where the threshold includes a threshold quantity of commands associated with a size of a cache of the memory system; and the condition for determining whether to write the second data to the memory system includes an amount of available memory within the cache.

Aspect 9: The method, apparatus, or non-transitory computer-readable medium of any of aspects 1 through 8, where the plurality of first logical block addresses are included in a set of sequential logical block addresses associated with a zone of memory within the memory system; at least one first write command of the plurality of first write commands skips a sequential logical block address of the set of sequential logical block addresses; and the threshold includes a threshold quantity of commands including the at least one first write command and one or more other first write commands received after the at least one first write command and before a target write command including the skipped sequential logical block address.

Aspect 10: The method, apparatus, or non-transitory computer-readable medium of aspect 9, further including operations, features, circuitry, logic, means, or instructions, or any combination thereof for incrementing a value of a counter in response to receipt of each of the at least one first write command and the one or more other first write commands and comparing the value of the counter to the threshold, where the automatic write mode of the memory system is disabled in response to the value of the counter satisfying the threshold.

Aspect 11: The method, apparatus, or non-transitory computer-readable medium of any of aspects 9 through 10, further including operations, features, circuitry, logic, means, or instructions, or any combination thereof for generating, in response to receipt of the at least one first write command, a skipped address pointer that points to the skipped sequential logical block address.

Aspect 12: The method, apparatus, or non-transitory computer-readable medium of aspect 11, further including operations, features, circuitry, logic, means, or instructions, or any combination thereof for receiving a third write command that indicates third data to be written to the skipped sequential logical block address; writing the third data to the memory system in accordance with the third write command; and deleting the skipped address pointer in response to writing the third data to the memory system.

Aspect 13: The method, apparatus, or non-transitory computer-readable medium of any of aspects 1 through 12, further including operations, features, circuitry, logic, means, or instructions, or any combination thereof for generating, in response to a first write command of the plurality of first write commands, a write pointer to a third logical block address of the plurality of first logical block addresses that is indicated via the first write command and updating, in response to receipt of each first write command of the plurality of first write commands, the write pointer to point to a respective first logical block address of the plurality of first logical block addresses indicated via a most recently received first write command.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
processing circuitry associated with one or more memory devices and configured to cause the apparatus to:
receive a plurality of first write commands that indicate first data to be written to a plurality of first logical block addresses within a memory system;
write, in accordance with an automatic write mode of the memory system and the plurality of first logical block addresses, the first data to the memory system in response to the plurality of first write commands;
disable the automatic write mode of the memory system in accordance with a quantity of first write commands included in the plurality of first write commands satisfying a threshold; and
determine, in accordance with disabling the automatic write mode and a condition associated with a second write command that indicates a second logical block address, whether to write second data indicated via the second write command to the memory system.

2. The apparatus of claim 1, wherein the processing circuitry is further configured to cause the apparatus to:
transmit, in accordance with determining not to write the second data to the memory system, an error message that indicates the second write command is invalid.

3. The apparatus of claim 2, wherein the processing circuitry is further configured to cause the apparatus to:
receive a retransmission of the second write command or a third write command in response to the error message.

4. The apparatus of claim 2, wherein the processing circuitry is further configured to cause the apparatus to:
transmit, in response to one or more third write commands, one or more error messages until a fourth write command that indicates a target logical block address is received, wherein the condition comprises the target logical block address, and wherein determining not to write the second data to the memory system is in accordance with the second logical block address indicated via the second write command being different from the target logical block address.

5. The apparatus of claim 4, wherein the processing circuitry is further configured to cause the apparatus to:
receive the fourth write command that indicates the target logical block address;
re-enable the automatic write mode of the memory system in response to the fourth write command that indicates the target logical block address;
receive, after re-enabling the automatic write mode, a retransmission of the second write command; and
write, in accordance with the automatic write mode, the second data to the memory system in response to the retransmission of the second write command.

6. The apparatus of claim 1, wherein the processing circuitry is further configured to cause the apparatus to:
write, in accordance with determining to write the second data to the memory system and in accordance with a manual write mode of the memory system, the second data indicated via the second write command to the memory system.

7. The apparatus of claim 6, wherein the processing circuitry is further configured to cause the apparatus to:
re-enable the automatic write mode of the memory system in accordance with the second logical block address comprising a target logical block address, wherein determining to write the second data to the memory system is in accordance with the second logical block address comprising the target logical block address.

8. The apparatus of claim 1, wherein:
the threshold comprises a threshold quantity of commands associated with a size of a cache of the memory system; and
the condition for determining whether to write the second data to the memory system comprises an amount of available memory within the cache.

9. The apparatus of claim 1, wherein:
the plurality of first logical block addresses are included in a set of sequential logical block addresses associated with a zone of memory within the memory system;
at least one first write command of the plurality of first write commands skips a sequential logical block address of the set of sequential logical block addresses; and
the threshold comprises a threshold quantity of commands including the at least one first write command and one or more other first write commands received after the at least one first write command and before a target write command comprising the skipped sequential logical block address.

10. The apparatus of claim 9, wherein the processing circuitry is further configured to cause the apparatus to:
increment a value of a counter in response to receipt of each of the at least one first write command and the one or more other first write commands; and
compare the value of the counter to the threshold, wherein the automatic write mode of the memory system is disabled in response to the value of the counter satisfying the threshold.

11. The apparatus of claim 9, wherein the processing circuitry is further configured to cause the apparatus to:
generate, in response to receipt of the at least one first write command, a skipped address pointer that points to the skipped sequential logical block address.

12. The apparatus of claim 11, wherein the processing circuitry is further configured to cause the apparatus to:
receive a third write command that indicates third data to be written to the skipped sequential logical block address;
write the third data to the memory system in accordance with the third write command; and
delete the skipped address pointer in response to writing the third data to the memory system.

13. The apparatus of claim 1, wherein the processing circuitry is further configured to cause the apparatus to:
generate, in response to a first write command of the plurality of first write commands, a write pointer to a third logical block address of the plurality of first logical block addresses that is indicated via the first write command; and
update, in response to receipt of each first write command of the plurality of first write commands, the write pointer to point to a respective first logical block address of the plurality of first logical block addresses indicated via a most recently received first write command.

14. A non-transitory computer-readable medium storing code, the code comprising instructions executable by one or more processors to:
receive a plurality of first write commands that indicate first data to be written to a plurality of first logical block addresses within a memory system;
write, in accordance with an automatic write mode of the memory system and the plurality of first logical block addresses, the first data to the memory system in response to the plurality of first write commands;
disable the automatic write mode of the memory system in accordance with a quantity of first write commands included in the plurality of first write commands satisfying a threshold; and
determine, in accordance with disabling the automatic write mode and a condition associated with a second write command that indicates a second logical block address, whether to write second data indicated via the second write command to the memory system.

15. The non-transitory computer-readable medium of claim 14, wherein the instructions are further executable by the one or more processors to:
transmit, in accordance with determining not to write the second data to the memory system, an error message that indicates the second write command is invalid.

16. The non-transitory computer-readable medium of claim 15, wherein the instructions are further executable by the one or more processors to:
receive a retransmission of the second write command or a third write command in response to the error message.

17. The non-transitory computer-readable medium of claim 15, wherein the instructions are further executable by the one or more processors to:
transmit, in response to one or more third write commands, one or more error messages until a fourth write command that indicates a target logical block address is received, wherein the condition comprises the target logical block address, and wherein determining not to write the second data to the memory system is in accordance with the second logical block address indicated via the second write command being different from the target logical block address.

18. The non-transitory computer-readable medium of claim 17, wherein the instructions are further executable by the one or more processors to:
receive the fourth write command that indicates the target logical block address;
re-enable the automatic write mode of the memory system in response to the fourth write command that indicates the target logical block address;
receive, after re-enabling the automatic write mode, a retransmission of the second write command; and
write, in accordance with the automatic write mode, the second data to the memory system in response to the retransmission of the second write command.

19. The non-transitory computer-readable medium of claim 14, wherein the instructions are further executable by the one or more processors to:
write, in accordance with determining to write the second data to the memory system and in accordance with a manual write mode of the memory system, the second data indicated via the second write command to the memory system.

20. The non-transitory computer-readable medium of claim 19, wherein the instructions are further executable by the one or more processors to:
re-enable the automatic write mode of the memory system in accordance with the second logical block address comprising a target logical block address, wherein determining to write the second data to the memory system is in accordance with the second logical block address comprising the target logical block address.

21. The non-transitory computer-readable medium of claim 14, wherein:
the threshold comprises a threshold quantity of commands associated with a size of a cache of the memory system; and
the condition for determining whether to write the second data to the memory system comprises an amount of available memory within the cache.

22. The non-transitory computer-readable medium of claim 14, wherein:
the plurality of first logical block addresses are included in a set of sequential logical block addresses associated with a zone of memory within the memory system;
at least one first write command of the plurality of first write commands skips a sequential logical block address of the set of sequential logical block addresses; and
the threshold comprises a threshold quantity of commands including the at least one first write command and one or more other first write commands received after the at least one first write command and before a target write command comprising the skipped sequential logical block address.

23. The non-transitory computer-readable medium of claim 22, wherein the instructions are further executable by the one or more processors to:
increment a value of a counter in response to receipt of each of the at least one first write command and the one or more other first write commands; and
compare the value of the counter to the threshold, wherein the automatic write mode of the memory system is disabled in response to the value of the counter satisfying the threshold.

24. The non-transitory computer-readable medium of claim 22, wherein the instructions are further executable by the one or more processors to:
generate, in response to receipt of the at least one first write command, a skipped address pointer that points to the skipped sequential logical block address.

25. A method, comprising:
receiving a plurality of first write commands that indicate first data to be written to a plurality of first logical block addresses within a memory system;
writing, in accordance with an automatic write mode of the memory system and the plurality of first logical block addresses, the first data to the memory system in response to the plurality of first write commands;
disabling the automatic write mode of the memory system in accordance with a quantity of first write commands included in the plurality of first write commands satisfying a threshold; and
determining, in accordance with disabling the automatic write mode and a condition associated with a second write command that indicates a second logical block address, whether to write second data indicated via the second write command to the memory system.
